(19) United States
(12) Patent Application Publication
(10) Pub. No.: US 2006/0099128 A1
(43) Pub. Date: May 11, 2006

(54) Synthetic magnesium silicate compositions and process for the production thereof

(76) Inventors: Alan Williams Andrews, Warrington (GB); Jane Doyle, Rossett (GB); Anne Pettitt, Widnes (GB); David Brian Shaw, Warrington (GB); Terence Timperley, Widnes (GB)

Correspondence Address: MEYERTONS, HOOD, KIVLIN, KOWERT & GOETZEL, P.C., 700 LAVACA, SUITE 800, AUSTIN, TX, 78701, US

(21) Appl. No.: 10/519,308

(22) PCT Filed: Jun. 20, 2003
(86) PCT No.: PCT/GB03/02646

§ 371 Date: Aug. 22, 2005

(30) Foreign Application Priority Data
Jun. 21, 2002 (GB) 0214355.0

(51) Int. Cl. C01B 33/24

(52) U.S. Cl. 423/331

(57) ABSTRACT

A synthetic magnesium silicate composition of the formula:
{[Si₈(MgₐLi_{b})O₂₀(OH)_{4-c}F_{c}]^{d-}d/nMⁿ⁺}_{w}{Na₂SO₄}ₓ{Na₂CO₃}_{y}{H₂O}_{z} where a is 4.5 to <6.0, b is from >0 to 1.5, c is from 0 to 4, d=12−2a−b, M is a cation, n is the valency of cation M, w is from 32.8 to 94.7 wt. %, x is from 0.3 to 32.0 wt. %, y is from 0 to 9.0 wt. %, and z is from 0 to 50 wt. %, is useful in paraffin wax dispersions as it does not discolour or yellow such dispersions

### BACKGROUND

This invention is concerned with synthetic magnesium silicate compositions and a process for the production thereof.

With the name “hectorite” has been ascribed to a natural trioctahedral smectite found at Hector, Calif., USA. This clay is an hydrous magnesium silicate having the ideal composition Si₈ Mg₆O₂₀(OH)₄ modified by having a portion of the Mg⁺² and OH⁻ ions replaced by Li+ and F− ions.

The synthesis of hydrous magnesium silicates similar to natural hectorite has been described by Granquist and Pollack in “Clays and Clay minerals” Vol. 8 (Proceedings of the 8^{th} National Conference on Clays and Clay Minerals) pages 150-169. In the process described by Granquist, gels of magnesium hydroxide and of silica are produced separately, are washed, are combined and are redispersed in water to form a suspension. Lithium hydroxide or lithium fluoride and sodium hydroxide are added to the suspension that is then treated hydrothermally by refluxing it with stirring until a product having a crystal structure similar to that of hectorite is formed.

While Granquist's product has the crystal structure similar to natural hectorite it does not have good rheological properties. Measuring the Bingham Yield Value of an aqueous dispersion of the substance provides a standard yardstick of theological properties of a substance. The term Bingham Yield Value (also known as Bingham Yield Stress, these terms being alternatives for the same property) is referred to in standard works on rheology for example in “Rheology Theory and Applications” F R Eirich (Acad. Press) Vol. 1 (1956) page 658 and “Colloidal Dispersions” L K Fisher (N.Y. Bureau of Standards) 2^{nd} Edition 1953, pages 150-170 and “The Chemistry and Physics of Clays and other Ceramic Materials” 3^{rd} Edition, page 463, A B Searle and R W Grimshaw.

The Bingham Yield Value may be determined by first obtaining a flow curve relating the shear stress to the rate of shear and then extrapolating the straight line section of the curve to the shear stress axis, the intercept being the Bingham Yield Value. It can conveniently be determined on any viscometer capable of measuring a range of shear rates and shear stresses.

The product of Granquist, when in the form of a dispersion obtained using 2 g silicate and 100 ml tap water, gives a Bingham Yield Value of only about 15 dynes per cm 2. This is a very low value, inferior to that given by natural hectorite. It's also gives a low static gel strength.

Processes for the production of synthetic hydrous magnesium silicate compositions having a crystal structure similar to natural hectorite but having better rheological properties than natural hectorite have been described in GB-A-1054111, GB-A-to1213122 and GB-A-1432770.

The process described in the GB-A-1054111 involves forming a slurry by co-precipitation by slowly combining with heating and agitation in an aqueous medium a constituent providing the magnesium ions with constituents providing the silicon (as silicates), hydroxyl and sodium ions and treating the precipitate hydrothermally to crystallise the synthetic mineral-like clay, washing and dewatering the resulting crystallised product, and drying the product at a temperature up to 450° C. The concentration of the slurry is desirably such that the concentration of the product formed is from 1% to 8% by weight, preferably 4% by weight. The hydrous magnesium silicate contains fluorine and lithium. The clay-like minerals provided have the structural formula:
(Si₈Mg₆₋ₓLiₓ.O₂₀.(OH)_{4-y}F_{y})^{x(-)}.x/nMnⁿ⁽⁺⁾
in which x is between 0 and 6, y is from 1 up to but excluding 4, and M is a cation. Li⁺ may be replaced by Na⁺.

The process described in GB-A-1213122 involves precipitating a magnesium silicate by combining an aqueous solution of a water soluble magnesium salt with an aqueous alkaline solution of one or more sodium compounds in the presence of dissolved silicon compound and hydrothermally treating the precipitate under pressure to crystallise the synthetic mineral-like clay, separating the resultant solid and liquid phases, washing the resulting crystallised product, and drying the product. The concentration of the precipitate is preferably not more than 5% by weight. The hydrous magnesium silicate product contains no fluorine, optionally contains lithium and has the general formula:
[Si₈MgₐLi_{b}H_{4+c}O₂₄]^{(12-2a-b-c)—}.M^{(12-2a-b-c)+}
where (i) M is a sodium, a lithium or an equivalent of an organic cation, and (ii) the value of a, b, and c is such that either a<6, b>0, c>0, b+c<2, and (a+b+c−6)<2; or a<6, b=0, c, 2 and (a+c−6)<2.

The process described in GB-A-1432770 involves the synthesis of an hydrous magnesium silicate having a crystal structure similar to that of hectorite and having the general formula:
[Si₈(Mg_{z}Li_{b}H_{c})O₂₀(OH)_{4-y}F_{y}]^{z-}.zM⁺
wherein a is 4.95 to 5.7, b is from 0 to 1.05, c is from 0 to <2, a+b+c is from >4 to <8, y is from 0 to <4, z=12−2a−b−c, and M is Na+ or Li⁺. The process comprises the sequential steps of forming an aqueous suspension of magnesium carbonate, forming a silica precipitate in the aqueous suspension magnesium carbonate, the proportions of magnesium provided by the magnesium carbonate and silica precipitated in the suspension corresponding to that of the formula of the magnesium silicate, maintaining the resulting mixture of magnesium carbonate and silica in the wet state and subjecting it to hydrothermal treatment by heating it in an aqueous medium and in the presence of the remaining constituents of the magnesium silicate in proportions within the ranges specified in the general formula and in the presence of excess dissolved sodium or lithium compound over that required to form the cation of the magnesium silicate until crystal growth occurs and separating the resulting crystalline product. The crystalline material resulting from the hydrothermal treatment is then separated by filtration, washed, and dried at a temperature not exceeding 450° C. The process described in GB-A-1432770 is distinguished from the processes described in GB-A-1054111 and GB-A-1213122 in that, in those processes, the Mg compound and the silica are co-precipitated.

The products of the processes described in the above prior art documents are characterised by providing dispersions having Bingham Yield Values substantially in excess of any known to be given by natural hectorite dispersions. However, it is known that small modifications of the composition of the prior art synthetic magnesium silicates or of the formulation of dispersions comprising such silicates can have significant deleterious effects upon these theological properties.

Some of the prior art products have found widespread use, by virtue of their excellent theological properties, in many applications, including in paints; cosmetic products; shampoos; detergents; disinfectants; toothpastes; paper manufacture, for example as fillers, retention and drainage aids, and in paper coatings; and drilling muds. The products of the above processes are commercially available as dry white powders, such as the products sold by Rockwood Additives Limited, England, under the trade mark “LAPONITE”. When fully dispersed and hydrated in water, the resulting composition is colourless and transparent.

When the products of the above processes are dispersed in paraffin wax, however, there is a tendency for the wax dispersion to discolour over a period of time.

### SUMMARY

It is an object of the present invention to provide synthetic magnesium silicate compositions that have similar colour and theological properties as the prior art products but which, when dispersed in paraffin wax, exhibit reduced or eliminated discoloration of the wax dispersion.

It is a further object of the present invention to provide a process for the preparation of such synthetic magnesium silicate compositions.

### DETAILED DESCRIPTION

In accordance with the first aspect of present invention there is provided a synthetic magnesium silicate composition of the formula:

$${\{ {[ {Si}_{8} ( {Mg}_{a} {Li}_{b} ) {{O}_{20} ( OH )}_{4 - c} {F}_{c} ]}^{d - \frac{d}{n}} {M}^{n +} \}}_{w} {\{ {Na}_{2} {SO}_{4} \}}_{x} {\{ {Na}_{2} {CO}_{3} \}}_{y} {\{ {H}_{2} O \}}_{z}$$

wherein a is 4.5 to <6.0, b is from >0 to 1.5, c is from 0 to 4, d=12−2a−b, M is a cation, n is the valency of the cation M, w is from 32.8 to 94.7% w/w, x is from 0.3 to 32.0% w/w, y is from 0 to 9.0% w/w, and z is from 0 to 50% w/w. Preferably a is between 5.30 and 5.68. Most Preferably a is between 5.42 and 5.55, and z is less than 2% w/w. M is preferably selected from Na, K, Li, an organic cation, such as a quaternary ammonium anion eg {R₂(CH₃)₂}⁺, where R is C₁₄ to C₂₂, preferably C₁₈, alkyl, and mixtures thereof. More preferably M is selected from Na, Li and mixtures thereof. Most preferably M is Na.

As only small modifications of the composition of the prior art synthetic magnesium silicates or of the formulation of dispersions comprising such silicates can have significant deleterious effects upon the rheological properties of compositions, it is surprising to find that the synthetic magnesium silicate compositions of the present invention have retained colour and rheological properties as the prior art products and, importantly, demonstrate a significantly reduced, if not eliminated, discoloration effect on wax dispersions.

Whilst the physical make-up of the compositions of the present invention is not fully understood, it is believed that of the compositions are complex, intimate, amorphous/crystalline blends of the relevant defined constituents. Accordingly, the above formula should be determined at the micro level. In other words, the compositions of the present invention are not simple dry blends of the defined constituents having a formulation corresponding to the above formula but determined at the macro level. Indeed, a dry blend of the relevant constituents having a formulation corresponding to the above formula when determined at the macro level, even when micronised to reduce the mixture particle size to less than 20 microns, simply does not demonstrate the advantages of the present invention, i.e. paraffin wax dispersions comprising such a simple blend will tend to discover or yellow.

In another aspect of the present invention, there is provided a process for the preparation of a synthetic magnesium silicate composition of the formula:

$${\{ {[ {Si}_{8} ( {Mg}_{a} {Li}_{b} ) {{O}_{20} ( OH )}_{4 - c} {F}_{c} ]}^{d - \frac{d}{n}} {M}^{n +} \}}_{w} {\{ {Na}_{2} {SO}_{4} \}}_{x} {\{ {Na}_{2} {CO}_{3} \}}_{y} {\{ {H}_{2} O \}}_{z}$$

wherein a is 4.5 to <6.0, b is from >0 to 1.5, c is from 0 to 4, d=12−2a−b, M is a cation, n is the valency of the cation M, w is from 32.8 to 94.7% w/w, x is from 0.3 to 32.0% w/w, y is from 0 to 9.0% w/w, and z is from 0 to 50% w/w. Preferably a is between 5.30 and 5.68. Most preferably a is between 5.42 and 5.55, and z is less than 2 w/w. M is preferably selected from Na, K, Li, an organic cation, such as a quaternary ammonium anion eg {R₂(CH₃)₂}⁺, where R is C₁₄ to C₂₂, preferably C₁₈, alkyl, and mixtures thereof. More preferably M is selected from Na, Li and mixtures thereof. Most preferably M is Na.

In both the composition and the process of the invention, it will be appreciated by a person skilled in the art that a+b may be less than or equal to 6.

In a first embodiment of the process of the invention, the process consists essentially of the following sequential steps:
(i) forming an aqueous suspension of magnesium carbonate,
(ii) forming a silica precipitate in the aqueous suspension of magnesium carbonate, the proportions of magnesium provided by the magnesium carbonate and of silica precipitated in the suspension corresponding to that of the formula of the magnesium silicate,
(iii) whilst maintaining the resulting mixture of magnesium carbonate and silica in the wet state, subjecting it to hydrothermal treatment by heating it in an aqueous medium and in the presence of the remaining constituents of the magnesium silicate in proportions within the ranges specified in the general formula thereof and in the presence of excess dissolved sodium or lithium compound over that required to form the cation thereof until crystal growth occurs,
(iv) separating the solid and liquid phases, and
(v) drying the resultant solid product at a temperature up to 450° C.

In a second embodiment of the process of the invention, the process consists essentially of the following sequential steps:
(i) forming an aqueous slurry from
(a) a water-soluble magnesium salt,
(b) sodium silicate,
(c) sodium carbonate or sodium hydroxide and
(d) material delivering lithium and fluoride ions selected from the group consisting of (A) lithium fluoride and (B) a lithium compound in conjunction with hydrofluoric acid, fluosilicic acid, sodium silicofluoride or sodium fluoride, such that in the slurry the following atomic ratios are present

$$\frac{Si}{F} = 0.5 to 5.1$$

$$\frac{Li}{Mg} = 0.1 to 1.0$$

$$\frac{Si}{Mg + Li} = 0.5 to 1.5$$

$$\frac{Na}{2 Mg + F \text{-} Li} = 1.0 to 2.0$$
the aqueous slurry being formed by co-precipitation by slowly combining the said magnesium salt and the said sodium silicate and the said sodium carbonate or sodium hydroxide, with heating and agitation, in an aqueous medium which contains the said material or materials delivering the lithium and fluoride ions;
(ii) taking the aqueous slurry so formed and, without washing free from soluble salts, hydrothermally treating it for about 10 to 20 hours until crystal growth occurs,
(iii) separating the solid and liquid phases, and
(iv) drying the resultant solid product at a temperature up to 450° C. In a third embodiment of the process of the present invention, the process consists essentially of include the following sequential steps:
   (i) precipitating a magnesium silicate having the value of “a” desired in the said composition by combining an aqueous solution of a water soluble magnesium salt with an aqueous alkaline solution of one or more sodium compounds in the presence of dissolved silicon-delivering material, the pH of the alkaline solution being maintained at 8 to 12.5 throughout,
   (ii) without first drying or washing this precipitate heating it to a temperature of at least 170° C. and the pressure of at least 6.9 bar (100 psi), the temperature being less than 370° C. and such that a liquid phase is present, until crystal growth occurs,
   (iii) separating the resultant solid and liquid phases, and
   (iv) drying the resultant solid product.

The compositions of the present invention retain similar theological properties to the products formed in GB-A-1054111, GB-A-1213122 and GB-A-1432770. The compositions may be supplied as dry white powders or as moist solids or in dispersions. Accordingly, the compositions the present invention may be used in the same type of applications as the prior art products. For example, the compositions may be used in paints; cosmetic products; shampoos; detergents; disinfectants; toothpastes; paper manufacture, for example as fillers, retention and drainage aids, and in paper coatings; and drilling muds. Such compositions have the advantage over the prior art products because the compositions do not yellow or discolour paraffin wax when dispersed therein.

### EXAMPLES

The following examples illustrate aspects of the invention, but are not in any way intended to limit the scope the invention.

### Example 1

### Preparation of Compositions of the Present Invention

Various compositions of the present invention, as set out in Table 1, can be prepared by the following process. To determine the amounts of, for example, lithium carbonate, magnesium sulphate, sodium silicate, and sodium carbonate employed in the process reference should be made to the formula of the desired synthetic magnesium silicate. (Should a fluorine containing product be desired, reference should first be made to the formula of the desired synthetic magnesium silicate to determine the quantity of fluorine needed in the desired synthetic magnesium silicate, and the quantity of a suitable fluorine containing material required for the process can then be determined.)

A measured quantity of lithium carbonate and water (sufficient to dissolve the measured quantity of lithium carbonate) is placed in a flask fitted with a stirrer, a heating mantle and a refluxing condenser. In a separate vessel, a measured quantity of magnesium sulphate is dissolved in sufficient water such that the solution was almost saturated and the solution added to the lithium carbonate solution. The mixture was brought to a temperature of at least 60° C. under reflux while stirring efficiently.

From a separate vessel a measured quantity of sodium carbonate solution is added slowly to the reaction vessel containing the lithium carbonate and magnesium sulphate solution. The addition is made over a period of up to one hour, while the reaction mixture is kept at 60° C. or greater and stirred efficiently throughout.

From a separate vessel a measured quantity of sodium silicate solution is added slowly to the reaction vessel containing the lithium carbonate, magnesium sulphate and sodium carbonate solution. The addition is made over a period of up to one hour, while the reaction mixture is kept at 60° C. or greater and stirred efficiently throughout.

The mixture is then boiled under reflux, with efficient stirring, for about 2 hours. The mixture is then transferred to a pressure vessel and heated at 202° C. or greater for at least 6 hours. After that, it is filtered under vacuum leaving a filter cake that is dried in trays at circa 110° C. and then ground to a white powder in a small mill.
In the worked examples, where reference is made to Silicate is meant a composition substantially of the formula:

$$\{ {[ {Si}_{8} ( {Mg}_{a} {Li}_{b} ) {{O}_{20} ( OH )}_{4 - c} {F}_{c} ]}^{d - \frac{d}{n}} {M}^{n +} \}$$

where a is 5.50, b is 0.3, c is 0, d is 0.7, n is 1 and M is Na.

TABLE 1

| % w/w Silicate | % w/w Na₂SO₄ | % w/w Na₂CO₃ | % w/w H₂O |
|---|---|---|---|
| 81.54 | 18.46 | 0 | 0 |
| 80.27 | 16.77 | 2.97 | 0 |
| 79.21 | 15.36 | 5.43 | 0 |
| 68.04 | 31.96 | 0 | 0 |
| 66.63 | 28.35 | 5.02 | 0 |
| 65.51 | 25.48 | 9.01 | 0 |
| 79.91 | 18.09 | 0 | 2 |
| 78.66 | 16.43 | 2.91 | 2 |
| 77.62 | 15.05 | 5.33 | 2 |
| 66.68 | 31.32 | 0 | 2 |
| 65.30 | 27.79 | 4.92 | 2 |
| 64.20 | 24.97 | 8.83 | 2 |
| 40.77 | 9.23 | 0 | 50 |
| 40.13 | 8.38 | 1.48 | 50 |
| 39.60 | 7.68 | 2.72 | 50 |
| 34.02 | 15.98 | 0 | 50 |
| 33.32 | 14.18 | 2.51 | 50 |
| 32.75 | 12.74 | 4.51 | 50 |
| 81.87 | 18.13 | 0 | 0 |
| 80.57 | 16.49 | 2.94 | 0 |
| 79.50 | 15.12 | 5.39 | 0 |
| 68.38 | 31.62 | 0 | 0 |
| 66.93 | 28.06 | 5.00 | 0 |
| 65.78 | 25.22 | 8.99 | 0 |
| 80.23 | 17.77 | 0 | 2 |
| 78.96 | 16.16 | 2.88 | 2 |
| 77.91 | 14.81 | 5.28 | 2 |
| 67.01 | 30.99 | 0 | 2 |
| 65.60 | 27.50 | 4.90 | 2 |
| 64.47 | 24.72 | 8.81 | 2 |
| 40.93 | 9.07 | 0 | 50 |
| 40.29 | 8.24 | 1.47 | 50 |
| 39.75 | 7.56 | 2.69 | 50 |
| 34.19 | 15.81 | 0 | 50 |
| 33.47 | 14.03 | 2.50 | 50 |
| 32.89 | 12.61 | 4.50 | 50 |
| 82.03 | 17.97 | 0 | 0 |
| 80.72 | 16.35 | 2.93 | 0 |
| 79.64 | 15.00 | 5.37 | 0 |
| 68.54 | 31.46 | 0 | 0 |
| 67.08 | 27.92 | 5.00 | 0 |
| 65.92 | 25.10 | 8.98 | 0 |
| 80.39 | 17.61 | 0 | 2 |
| 79.11 | 16.02 | 2.87 | 2 |
| 78.04 | 14.70 | 5.26 | 2 |
| 67.17 | 30.83 | 0 | 2 |
| 65.74 | 27.36 | 4.90 | 2 |
| 64.60 | 24.60 | 8.80 | 2 |
| 41.01 | 8.99 | 0 | 50 |
| 40.36 | 8.18 | 1.46 | 50 |
| 39.82 | 7.50 | 2.68 | 50 |
| 34.27 | 15.73 | 0 | 50 |
| 33.54 | 13.96 | 2.50 | 50 |
| 32.96 | 12.55 | 4.49 | 50 |
| 82.12 | 17.88 | 0 | 0 |
| 80.81* | 16.27* | 2.92* | 0* |
| 79.72 | 14.92 | 5.35 | 0 |
| 68.64 | 31.36 | 0 | 0 |
| 67.17 | 27.83 | 4.99 | 0 |
| 66.00 | 25.02 | 8.98 | 0 |
| 80.48 | 17.52 | 0 | 2 |
| 79.20** | 15.94** | 2.86** | 2** |
| 78.13 | 14.63 | 5.25 | 2 |
| 67.27 | 30.73 | 0 | 2 |
| 65.83 | 27.28 | 4.89 | 2 |
| 64.68 | 24.52 | 8.80 | 2 |
| 41.06 | 8.94 | 0 | 50 |
| 40.41 | 8.13 | 1.46 | 50 |
| 39.86 | 7.46 | 2.68 | 50 |
| 34.32 | 15.68 | 0 | 50 |
| 33.59 | 13.92 | 2.50 | 50 |
| 33.00 | 12.51 | 4.49 | 50 |
| 82.18 | 17.82 | 0 | 0 |
| 80.87 | 16.22 | 2.91 | 0 |
| 79.78 | 14.88 | 5.35 | 0 |
| 68.71 | 31.29 | 0 | 0 |
| 67.23 | 27.78 | 4.99 | 0 |
| 66.05 | 24.97 | 8.97 | 0 |
| 80.54 | 17.46 | 0 | 2 |
| 79.25 | 15.89 | 2.86 | 2 |
| 78.18 | 14.58 | 5.24 | 2 |
| 67.33 | 30.67 | 0 | 2 |
| 65.89 | 27.22 | 4.89 | 2 |
| 64.73 | 24.47 | 8.79 | 2 |
| 41.09 | 8.91 | 0 | 50 |
| 40.44 | 8.11 | 1.46 | 50 |
| 39.89 | 7.44 | 2.67 | 50 |
| 34.35 | 15.65 | 0 | 50 |
| 33.62 | 13.89 | 2.50 | 50 |
| 33.03 | 12.49 | 4.49 | 50 |
| 82.33 | 17.67 | 0 | 0 |
| 81.01 | 16.08 | 2.90 | 0 |
| 79.91 | 14.76 | 5.32 | 0 |
| 68.87 | 31.13 | 0 | 0 |
| 67.38 | 27.64 | 4.98 | 0 |
| 66.19 | 24.85 | 8.96 | 0 |
| 80.69 | 17.31 | 0 | 2 |
| 79.39 | 15.76 | 2.84 | 2 |
| 78.31 | 14.47 | 5.22 | 2 |
| 67.49 | 30.51 | 0 | 2 |
| 66.03 | 27.08 | 4.88 | 2 |
| 64.86 | 24.35 | 8.78 | 2 |
| 41.17 | 8.83 | 0 | 50 |
| 40.51 | 8.04 | 1.45 | 50 |
| 39.96 | 7.38 | 2.66 | 50 |
| 34.44 | 15.56 | 0 | 50 |
| 33.69 | 13.82 | 2.49 | 50 |
| 33.09 | 12.43 | 4.48 | 50 |
| 69.38 | 30.62 | 0 | 0 |
| 67.83 | 27.20 | 4.97 | 0 |
| 66.60 | 24.47 | 8.93 | 0 |
| 81.15 | 16.85 | 0 | 2 |
| 79.83 | 15.36 | 2.80 | 2 |
| 78.73 | 14.12 | 5.15 | 2 |
| 67.99 | 30.01 | 0 | 2 |
| 66.48 | 26.66 | 4.87 | 2 |
| 65.27 | 23.98 | 8.75 | 2 |
| 41.40 | 8.60 | 0 | 50 |
| 40.73 | 7.84 | 1.43 | 50 |
| 40.17 | 7.20 | 2.63 | 50 |
| 34.69 | 15.31 | 0 | 50 |
| 33.92 | 13.60 | 2.48 | 50 |
| 33.30 | 12.23 | 4.47 | 50 |
| 82.80 | 17.20 | 0 | 0 |
| 81.46 | 15.68 | 2.86 | 0 |
| 80.34 | 14.40 | 5.26 | 0 |
| 70.12 | 29.88 | 0 | 0 |
| 68.50 | 26.56 | 4.94 | 0 |
| 67.20 | 23.91 | 8.89 | 0 |
| 81.80 | 16.20 | 0 | 2 |
| 80.45 | 14.80 | 2.75 | 2 |
| 79.32 | 13.62 | 5.06 | 2 |
| 68.71 | 29.29 | 0 | 2 |
| 67.13 | 26.03 | 4.84 | 2 |
| 65.86 | 23.43 | 8.71 | 2 |
| 41.73 | 8.27 | 0 | 50 |
| 41.05 | 7.55 | 1.40 | 50 |
| 40.47 | 6.95 | 2.58 | 50 |
| 35.06 | 14.94 | 0 | 50 |
| 34.25 | 13.28 | 2.47 | 50 |
| 33.60 | 11.95 | 4.44 | 50 |
| 83.47 | 16.53 | 0 | 0 |
| 82.09 | 15.10 | 2.81 | 0 |
| 80.94 | 13.90 | 5.17 | 0 |

### Example 2

### Paraffin Wax Dispersions

Comparative 1

A paraffin wax dispersion was prepared by mixing 100 g of Laponite® RD synthetic hectorite available from Rockwood Absorbents Limited, Widnes, England, in 5 l of hot paraffin wax. The dispersion was allowed to cool and then a sample was put into a closed jar, which was then closed and then placed on the laboratory shelf. The jar was not in direct sunlight. After two months, the jar was revisited and it was noted that the sample had turned a pale yellow colour, thereby indicating the discoloration of the dispersion.

Comparative 2

A paraffin wax dispersion was prepared by mixing 80 g of Laponite® RD synthetic hectorite available from Rockwood Absorbents Limited, Widnes, England, 18 g of Na₂SO₄ and 2 g of Na₂CO₃ (particle size <10 microns, pre-mixed in microniser) in 5 l of hot paraffin wax. The dispersion was allowed to cool and then a sample was put into a closed jar, which was then closed and then placed on the laboratory shelf. The jar was not in direct sunlight. After two months, the jar was revisited and it was noted that the sample had turned a pale yellow colour, thereby indicating the discoloration of the dispersion.

Synthetic Magnesium Silicate Invention

A paraffin wax dispersion was prepared by mixing 100 g of composition ** (as indicated in Table 1) in 5 l of hot paraffin wax. The dispersion was allowed to cool and then a sample was put into a closed jar, which was then closed and then placed on the laboratory shelf. The jar was not in direct sunlight. After two months, the jar was revisited and it was noted that the sample the dispersion was the same colour as it was two months before, thereby indicating no discoloration of the dispersion.

### Example 3

### Retention Aid

To demonstrate that the compositions of the present invention retain rheological properties similar to the prior art synthetic silicate compositions, the performances as retention aids of the two compositions of the invention * and ** were compared against Laponite RD (a synthetic hectorite available from Rockwood Additives Limited, Widnes, England). The compositions were tested under total first pass retention conditions, a standard procedure well known in the papermaking industry. When used in combination with a commercially available high molecular weight cationic polymeric retention aid, the results in Table 2 indicate that the compositions of the present invention perform as effectively as Laponite RD as a retention aid.

TABLE 2

| Sample | Total First Pass Retention % |
|---|---|
| Blank-no retention aid | 71.8 |
| Polymer 0.22 Kg/1000 Kg of paper | 75.7 |
| produced | |
| Polymer 0.22 Kg/1000 Kg of paper | 80 |
| produced + Laponite RD 0.44 | |
| Kg/1000 Kg of paper produced | |
| Polymer 0.22 Kg/1000 Kg of paper | 80 |
| produced + Silicate* 0.44 | |
| Kg/1000 Kg of paper produced | |
| Polymer 0.22 Kg/1000 Kg of paper | 80 |
| produced + Silicate* 0.44 | |
| Kg/1000 Kg of paper produced | |

1. A synthetic magnesium silicate composition of the formula:
$${\{ {[ {Si}_{8} ( {Mg}_{a} {Li}_{b} ) {{O}_{20} ( OH )}_{4 - c} {F}_{c} ]}^{d - \frac{d}{n}} {M}^{n +} \}}_{w} {\{ {Na}_{2} {SO}_{4} \}}_{x} {\{ {Na}_{2} {CO}_{3} \}}_{y} {\{ {H}_{2} O \}}_{z}$$
wherein a is 4.5 to <6.0, b is from >0 to 1.5, c is from 0 to 4, d=12−2a−b, M is a cation, n is the valency of the cation M, w is from 32.8 to 94.7 wt. %, x is from 0.3 to 32.0 wt. %, y is from 0 to 9.0 wt. %, and z is from 0 to 50 wt. %.

2. A process for the preparation of a synthetic magnesium silicate composition of the formula:
$${\{ {[ {Si}_{8} ( {Mg}_{a} {Li}_{b} ) {{O}_{20} ( OH )}_{4 - c} {F}_{c} ]}^{d - \frac{d}{n}} {M}^{n +} \}}_{w} {\{ {Na}_{2} {SO}_{4} \}}_{x} {\{ {Na}_{2} {CO}_{3} \}}_{y} {\{ {H}_{2} O \}}_{z}$$
wherein a is 4.5 to <6.0, b is from >0 to 1.5, c is from 0 to 4, d=12−2a−b, M is Na or Li, n is 1, w is from 32.8 to 94.7 wt. %, x is from 0.3 to 32.0 wt. %, y is from 0 to 9.0 wt. %, and z is from 0 to 50 wt. %, the process comprising:
(i) forming an aqueous suspension of magnesium carbonate;
(ii) forming a silica precipitate in the aqueous suspension of magnesium carbonates;
the proportions of magnesium provided by the magnesium carbonate and of silica precipitated in the suspension corresponding to that of the formula of the magnesium silicate;
(iii) whilst maintaining the resulting mixture of magnesium carbonate and silica in the wet state, subjecting it to hydrothermal treatment by heating it in an aqueous medium and in the presence of the remaining constituents of the magnesium silicate in proportions within the ranges specified in the general formula thereof and in the presence of excess dissolved sodium or lithium compound over that required to form the cation thereof until crystal growth occurs;
(iv) separating the solid and liquid phases; and
(v) drying the resultant solid product at a temperature up to 450° C.

3. A process for the preparation of a synthetic magnesium silicate composition of the formula:
$${\{ {[ {Si}_{8} ( {Mg}_{a} {Li}_{b} ) {{O}_{20} ( OH )}_{4 - c} {F}_{c} ]}^{d - \frac{d}{n}} {M}^{n +} \}}_{w} {\{ {Na}_{2} {SO}_{4} \}}_{x} {\{ {Na}_{2} {CO}_{3} \}}_{y} {\{ {H}_{2} O \}}_{z}$$
wherein a is 4.5 to <6.0, b is from >0 to 1.5, c is from 0 to 4, d=12−2a−b, M is Na or Li, n is 1, w is from 32.8 to 94.7 wt. %, x is from 0.3 to 32.0 wt. %, y is from 0 to 9.0 wt. %, and z is from 0 to 50 wt. %, the process comprising:
(i) forming an aqueous slurry from
(a) a water-soluble magnesium salt;
(b) sodium silicate;
(c) sodium carbonate or sodium hydroxide; and
(d) material delivering lithium and fluoride ions selected from the group consisting of (A) lithium fluoride and (B) a lithium compound in conjunction with hydrofluoric acid, fluosilicic acid, sodium silicofluoride or sodium fluoride, such that in the slurry the following atomic ratios are present
$$\frac{Si}{F} = 0.5 to 5.1$$
$$\frac{Li}{Mg} = 0.1 to 1.0$$
$$\frac{Si}{Mg + Li} = 0.5 to 1.5$$
$$\frac{Na}{2 Mg + F \text{-} Li} = 1.0 to 2.0$$
the aqueous slurry being formed by co-precipitation by slowly combining the said magnesium salt and the said sodium silicate and the said sodium carbonate or sodium hydroxide, with heating and agitation, in an aqueous medium which contains the said material or materials delivering the lithium and fluoride ions;
(ii) taking the aqueous slurry so formed and, without washing free from soluble salts, hydrothermally treating it for about 10 to 20 hours until crystal growth occurs;
(iii) separating the solid and liquid phases; and
(iv) drying the resultant solid product at a temperature up to 450° C.

4. A process for the preparation of a synthetic magnesium silicate composition of the formula:
$${\{ {[ {Si}_{8} ( {Mg}_{a} {Li}_{b} ) {{O}_{20} ( OH )}_{4 - c} {F}_{c} ]}^{d - \frac{d}{n}} {M}^{n +} \}}_{w} {\{ {Na}_{2} {SO}_{4} \}}_{x} {\{ {Na}_{2} {CO}_{3} \}}_{y} {\{ {H}_{2} O \}}_{z}$$
wherein a is 4.5 to <6.0, b is from >0 to 1.5, c is from 0 to 4, d=12−2a−b, M is Na or Li, n is 1, w is from 32.8 to 94.7 wt. %, x is from 0.3 to 32.0 wt. %, y is from 0 to 9.0 wt. %, and z is from 0 to 50 wt. %, the process comprising:
(i) precipitating a magnesium silicate having the value of “a” desired in the said composition by combining an aqueous solution of a water soluble magnesium salt with an aqueous alkaline solution of one or more sodium compounds in the presence of dissolved silicon-delivering material, the pH of the alkaline solution being maintained at 8 to 12.5 throughout;
(ii) without first drying or washing this precipitate heating it to a temperature of at least 170° C. and the pressure of at least 6.9 bar (100 psi), the temperature being less than 370° C. and such that a liquid phrases present, until crystal growth occurs;
(iii) separating the resultant solid and liquid phrases; and
(iv) drying the resultant solid product.

5. The composition of claim 1, wherein a is from 5.30 to 5.68.

6. The composition of claim 1, wherein z is less than 2.

7. The composition of claim 1, wherein M is selected from Na, K, Li, an organic cation, and mixtures thereof.

8. The composition of claim 5, wherein z is less than 2.

9. The composition of claim 5, wherein M is selected from Na, K, Li, an organic cation, and mixtures thereof.

10. The composition of claim 6, wherein M is selected from Na, K, Li, an organic cation, and mixtures thereof.

11. The process of claim 2, wherein a is from 5.30 to 5.68.

12. The process of claim 3, wherein a is from 5.30 to 5.68.

13. The process of claim 4, wherein a is from 5.30 to 5.68.

14. The process of claim 2, wherein z is less than 2.

15. The process of claim 3, wherein z is less than 2.

16. The process of claim 4, wherein z is less than 2.

17. The process of claim 2, wherein M is selected from Na, K, Li, an organic cation, and mixtures thereof.

18. The process of claim 3, wherein M is selected from Na, K, Li, an organic cation, and mixtures thereof.

19. The process of claim 4, wherein M is selected from Na, K, Li, an organic cation, and mixtures thereof.
